(19) United States
(12) Patent Application Publication
(10) Pub. No.: US 2024/0087377 A1
(43) Pub. Date: Mar. 14, 2024

(54) INTELLIGENT COMPONENTS FOR LOCALIZED DECISION MAKING

(71) Applicant: GM Cruise Holdings LLC, San Francisco, CA (US)

(72) Inventor: Burkay Donderici, Burlingame, CA (US)

(21) Appl. No.: 17/942,929

(22) Filed: Sep. 12, 2022

(51) Int. Cl. G07C 5/08

(52) U.S. Cl. CPC G07C 5/0816; G07C 5/0841

(57) ABSTRACT

Aspects of the subject technology relate to intelligent components for a vehicle. A system can include a centralized computer system of a vehicle, first and second sensors, and a component of the vehicle coupled to the centralized computer system and the second sensor. The component comprises a localized computer system that is configured to receive a first control signal from the centralized computer system that is generated based on sensor data gathered by the first sensor. The localized computer system is also configured to generate a second control signal based on sensor data gathered by the second sensor, and locally determine whether to control the component according to either the first control signal or the second control signal. The localized computer system can also control the component according to either the first control signal or the second control signal.

### BACKGROUND

### 1. Technical Field

The present disclosure generally relates to intelligent components of a vehicle and, more specifically, to intelligent components of a vehicle for localized decision making.

### 2. Introduction

An autonomous vehicle (AV) is a motorized vehicle that can navigate without a human driver. An exemplary autonomous vehicle can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system. Typically, the sensors are mounted at fixed locations on the autonomous vehicles.

Current AVs are largely centralized with only a single computer system or “brain” making decisions about the AV behavior. There are reflexive paths in the AV that make decisions using different compute paths, but these paths use the same or co-located hard wiring. This is problematic because this introduces a weak point in the system which can become a safety gap through hardwire failure, local mechanical effects, or malicious activities.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example system environment that can be used to facilitate AV dispatch and operations, according to some examples of the present disclosure;

FIG. 2 illustrates a conceptual diagram of a vehicle with intelligent components for making localized decisions in controlling operation of the vehicle, according to some examples of the present disclosure;

FIG. 3 illustrates a flowchart for an example method of locally controlling a component of a vehicle through a localized computer system, according to some examples of the present disclosure;

FIG. 4 illustrates a flowchart for an example method of centrally managing a vehicle based on either or both perceived and predicted operations of an intelligent component, according to some examples of the present disclosure;

FIG. 5 is an example of a deep learning neural network, according to some examples of the present disclosure; and

FIG. 6 illustrates an example processor-based system with which some aspects of the subject technology can be implemented, according to some examples of the present disclosure.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

One aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

As discussed previously, current AVs are largely centralized with only a single computer system or “brain” making decisions about the AV behavior. There are reflexive paths in the AV that make decisions using different compute paths, but these paths use the same or co-located hard wiring. This is problematic because this introduces a weak point in the system which can become a safety gap through hardwire failure, local mechanical effects, or malicious activities.

The disclosed technology addresses the problems associated with a centralized computer system for a vehicle by integrating intelligent components into the vehicle. More specifically, the disclosed technology includes components with localized computer systems that can make localized decisions for controlling the components independent of a centralized computer system.

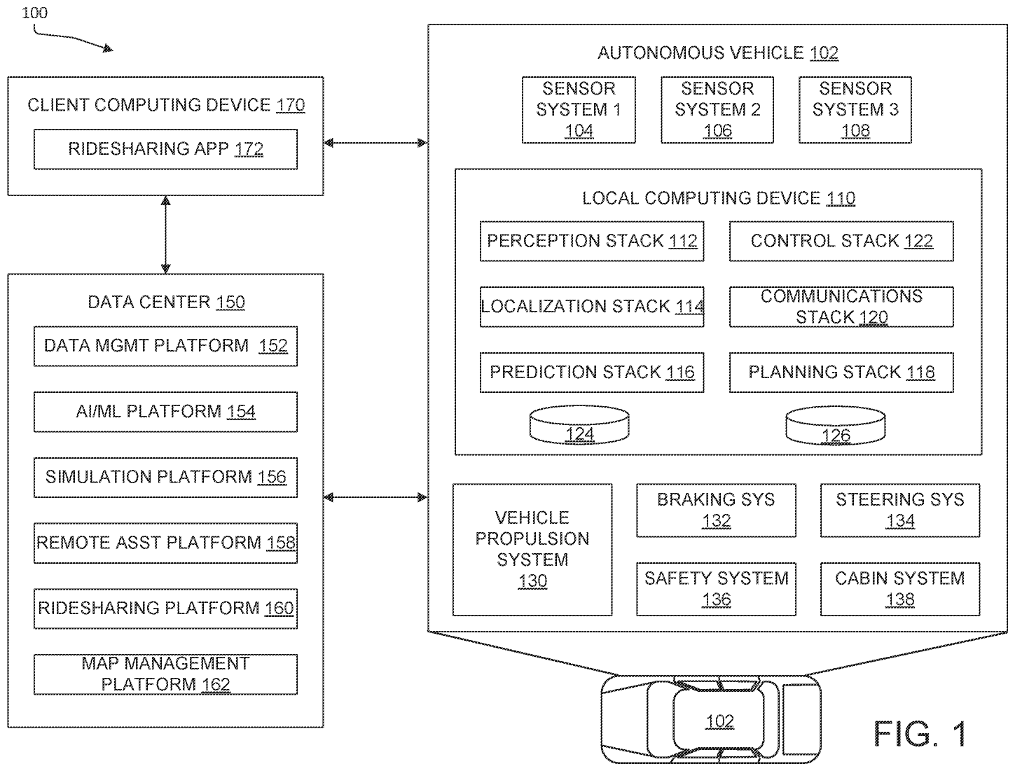

FIG. 1 is a diagram illustrating an example AV environment 100, according to some examples of the present disclosure. One of ordinary skill in the art will understand that, for the AV management system 100 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill in the art will appreciate that such variations do not depart from the scope of the present disclosure.

In this example, the AV management system 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include one or more types of sensors and can be arranged about the AV 102. For instance, the sensor systems 104-108 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other examples may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some examples, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can identify environmental uncertainties, such as where to look for moving objects, flag areas that may be obscured or blocked from view, and so forth. In some examples, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 114 can determine the AV's position and orientation (pose) using different methods from multiple systems (e.g., GPS, IMUS, cameras, LIDAR, RADAR, ultrasonic sensors, the HD geospatial database 126, etc.). For example, in some cases, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some examples, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

The communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 126 can store HD maps and related data of the streets upon which the AV 102 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112-122, and other components of the AV 102 and/or data received by the AV 102 from remote systems (e.g., the data center 150, the client computing device 170, etc.). In some examples, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ridesharing platform 160, and a map management platform 162, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridesharing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridesharing platform 160, the map management platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from a cartography platform (e.g., map management platform 162); modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridesharing platform 160 can interact with a customer of a ridesharing service via a ridesharing application 172 executing on the client computing device 170. The client computing device 170 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ridesharing application 172. The client computing device 170 can be a customer's mobile computing device or a computing device integrated with the AV 102 (e.g., the local computing device 110). The ridesharing platform 160 can receive requests to pick up or drop off from the ridesharing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some embodiments, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ridesharing platform 160 may incorporate the map viewing services into the client application 172 to enable passengers to view the AV 102 in transit en route to a pick-up or drop-off location, and so on.

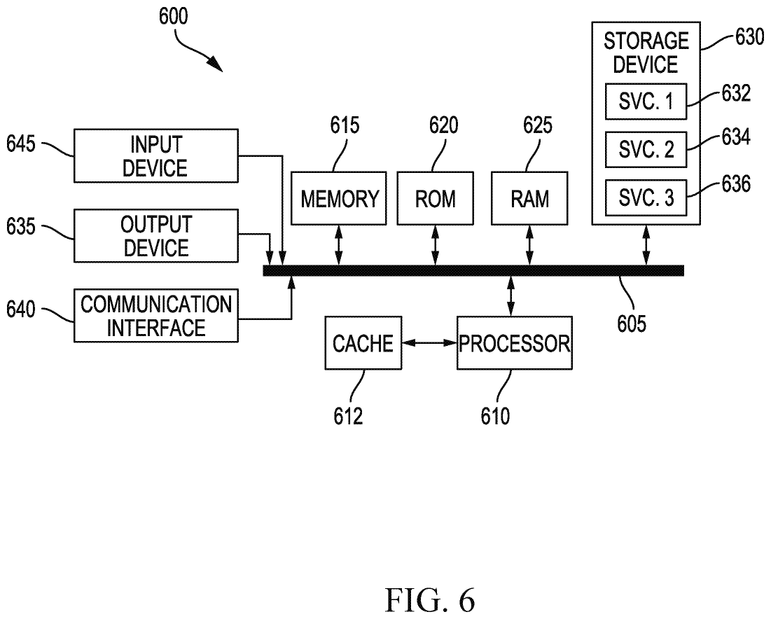

While the autonomous vehicle 102, the local computing device 110, and the autonomous vehicle environment 100 are shown to include certain systems and components, one of ordinary skill will appreciate that the autonomous vehicle 102, the local computing device 110, and/or the autonomous vehicle environment 100 can include more or fewer systems and/or components than those shown in FIG. 1. For example, the autonomous vehicle 102 can include other services than those shown in FIG. 1 and the local computing device 110 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 1. An illustrative example of a computing device and hardware components that can be implemented with the local computing device 110 is described below with respect to FIG. 6.

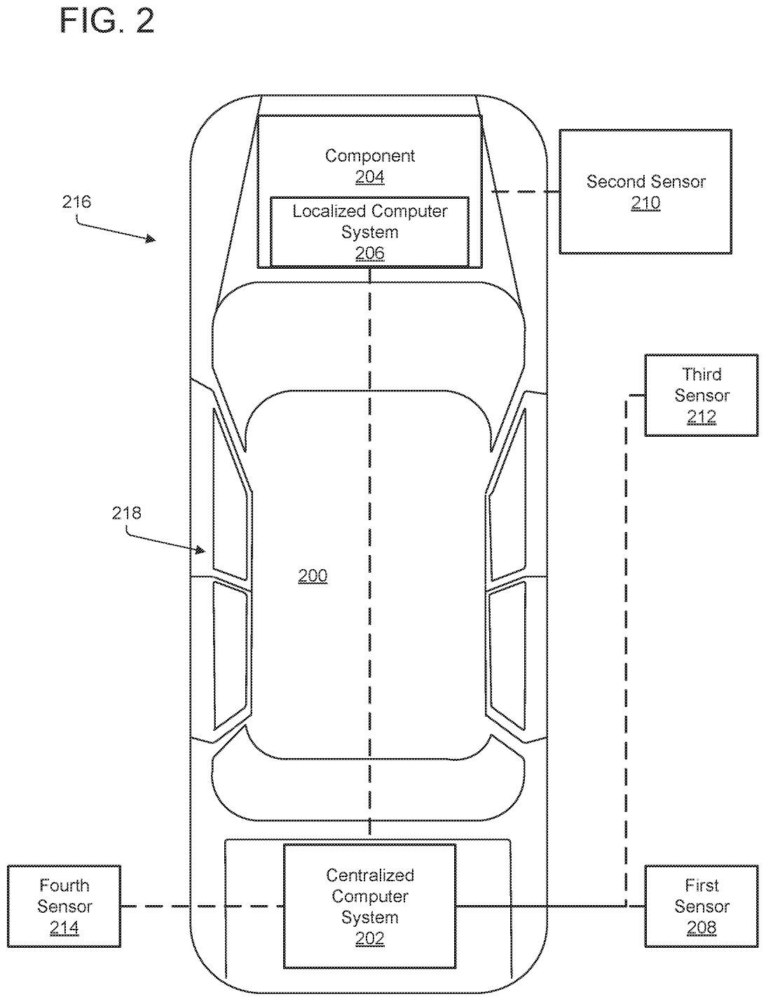

The disclosure now continues with a discussion of intelligent components for making localized control decisions in a vehicle. Specifically, FIG. 2 illustrates a conceptual diagram of a vehicle 200 with intelligent components for making localized decisions in controlling operation of the vehicle 200. The vehicle 200 includes a centralized computer system 202, a component 204, and a localized computer system 206. The centralized computer system 202 can implement various components for controlling, at least in part, operation of the vehicle from a centralized location. Specifically, the centralized computer system 202 can implement a software stack, such as the software stacks described in FIG. 1, for autonomously controlling operation of the vehicle 200 operating as an AV. The centralized computer system 202 is connected to sensors that are both near and far to the system 202 itself, and has relatively larger compute power that is used to do sensor fusion (fusing of sensor information from near and far sensors). A near sensor may be located 0.1 to 10 inches from the computer system. A far sensor may be located 30 inches to 2000 inches from the computer system. A far sensor connection to the central computer system passes through a relatively long path through the AV 200 and hence it is relatively more susceptible to large mechanical effects (such as a crash).

The component 204 is an applicable component of the vehicle 200 that can be actuated. Specifically, the component 204 is an applicable component of the vehicle 200 that can be actuated to control operation of the vehicle 200. For example, the component 204 can include tires, brakes, engine wipers, suspension, door locks, automatic windows, a moonroof, a sunroof, wheels, air intakes, spoilers, fill fuel tank doors, auto mirrors, vehicle signals, and belt systems.

The localized computer system 206 functions according to an applicable computer system for the component 204. Specifically, the localized computer system 206 can perform compute functions for ultimately affecting operation of the component 204. For example, the localized computer system 206 can execute a control signal to cause the component 204 to operate in a specific way. The localized computer system 206 is shown as being part of the component 204, however, the localized computer system 206 can be implemented separate from the component 204. Further, the localized computer system 206 can be specific to the component 204. For example, the localized computer system 206 can be used exclusively by the component 204 for controlling operation of the component 204. Alternatively, the localized computer system 206 can be shared by multiple components

The localized computer system 206 is localized with respect to the component 204. Localized, as used herein with respect to the localized computer system 206, can include a physical aspect. Specifically, the localized computer system 206 can be physically located in the same area of the vehicle as the component 204. Same area may be within a range of 10 inches. Further, localized, as used herein with respect to the localized computer system 206, can include a logical aspect. Specifically and as discussed previously, the localized computer system 206 can be unique to the component 204 or a specific subset of components including the component 204. More specifically, the localized computer system 206 is distinct from the centralized computer system 202 and can be used exclusively by the component 204, or a specific subset of components, as part of locally controlling operation of the component 204. In locally controlling operation of the component 204, the localized computer system 206 can operate in conjunction with the centralized computer system 202. For example and as will be discussed in greater detail later, the localized computer system 206 can locally determine whether to use a control signal that is generated by the centralized computer system 202 to control the component 204.

By operating with a localized computer system 206 that functions to locally control operation of the component 204, the component 204, e.g. in combination with the localized computer system 206, can operate as an intelligent component. Specifically, the component 204 can operate distinctly from the centralized computer system 202 to operate as an intelligent component. For example, the front brakes can act as an intelligent component by operating with a localized computer system to make braking decisions that override input form the centralized computer system 202.

In integrating intelligent components, e.g. the component 204, the vehicle 200 can solve the previously described deficiencies associated with operating vehicle solely through a centralized computer. Specifically, the vehicle 200 can react more quickly to imminent danger situations on the road. More specifically, due to the independent nature of processing of the component 204, the reaction time of the component 204 can be minimized beyond what is possible with the reflexive compute paths of the vehicle 200, which use the centralized computer system 202. For example, the vehicle 200 can make a faster localized decisions in reacting to a person suddenly jumping in front of the vehicle 200. In another example, brakes 216 of the vehicle 200 can act as an intelligent component and independently stop the vehicle 200 when a crash is detected, e.g. through perceived risk accelerometers or mechanical deformation sensors. In yet another example, an engine of the vehicle 200 can act as an intelligent component and independently shut down air intake if smoke is detected, e.g. from cameras. In another example, door locks 218 of the vehicle 200 can act as an intelligent component and independently disengage if an emergency is detected in a cabin of the vehicle 200. The vehicle 200 can also be more resilient to mechanical damage that may occur such as in a crash or vehicle mechanical malfunctions. For example, in case the communication link that connects the brakes of 200 to the centralized computer system is damaged in an accident, the local computer system can still detect the accident or malfunction using the second sensor 210 and react using the component 204.

The example vehicle 200 shown in FIG. 2 also includes a first sensor 208, a second sensor 210, a third sensor 212, and a fourth sensor 214. The first sensor 208, the third sensor 212, and the fourth sensor 214 can be applicable sensors that are utilized by a vehicle, e.g. AV. Specifically, one or a combination of the first sensor 208, the third sensor 212, and the fourth sensor 214 can be expensive sensors, e.g. relative to the second sensor 210. Specifically, the first sensor 208 can be a LIDAR or RADAR sensor. The first sensor 208, the third sensor 212, and the fourth sensor 214 are coupled to the centralized computer system 202. As the centralized computer system 202 is connected to the component 204, the first sensor 208, the third sensor 212, and the fourth sensor 214 can be connected to the component 204 through the centralized computer system 202. Specifically, and as shown in FIG. 2, the first sensor 208, the third sensor 212, and the fourth sensor 214 are not directly connected to the component 204. In being coupled to the centralized computer system 202, sensor data gathered by the first sensor 208, the third sensor 212, and the fourth sensor 214 can be accessed by the centralized computer system 202, while the sensors are distributed throughout the vehicle, as shown in FIG. 2.

The second sensor 210 can include an applicable sensor that gathers sensor data for independently controlling a component of the vehicle, e.g. the component 204. Specifically, the second sensor 210 can be a cheaper sensor, e.g. relative to the first sensor 208. For example, the second sensor 210 can include a low-resolution camera, an inertial sensor, an ultrasonic sensor, a contact sensor, a pressure sensor, or a temperature sensor. The second sensor 210 can be specific to the component 204. In being specific to the component 204, the second sensor can be used in providing sensor data for controlling the component 204. Further, in being specific to the component 204, the second sensor can be localized, e.g. physically, with respect to the component 204.

Either or both the first sensor 208 and the second sensor 210 can be used in controlling operation of the component 204. Specifically, sensor data gathered by the first sensor 208 can be used by the centralized computer system 202 to generate a first control signal. The centralized computer system 202 can pass the first control signal to the component 204, and the component 204 can operate according to the first control signal. For example, the centralized computer system 202 can pass a control signal for steering the tires of the vehicle based on LIDAR data capture by a LIDAR sensor. With respect to the second sensor 210, sensor data gathered by the second sensor 210 can be used by localized computer system 206 to generate a second control signal. The localized computer system 206 can then use the second control signal in controlling operation of the component 204. Specifically and further in the example, the localized computer system 206 can generate a control signal from an ultrasonic sensor to locally control steering of the tires, e.g. irrespective of the control signal generated based on the LIDAR data.

The localized computer system 206 can receive both the first control signal associated with the first sensor 208 and the second control signal associated with the second sensor 210. In turn and as will be discussed in greater detail later, the localized computer system 206 can determine whether to control the component 204 according to the first control signal or the second control signal. This decision made by the localized computer system 206 can be made independently from the centralized computer system 202, e.g. locally with respect to the component 204.

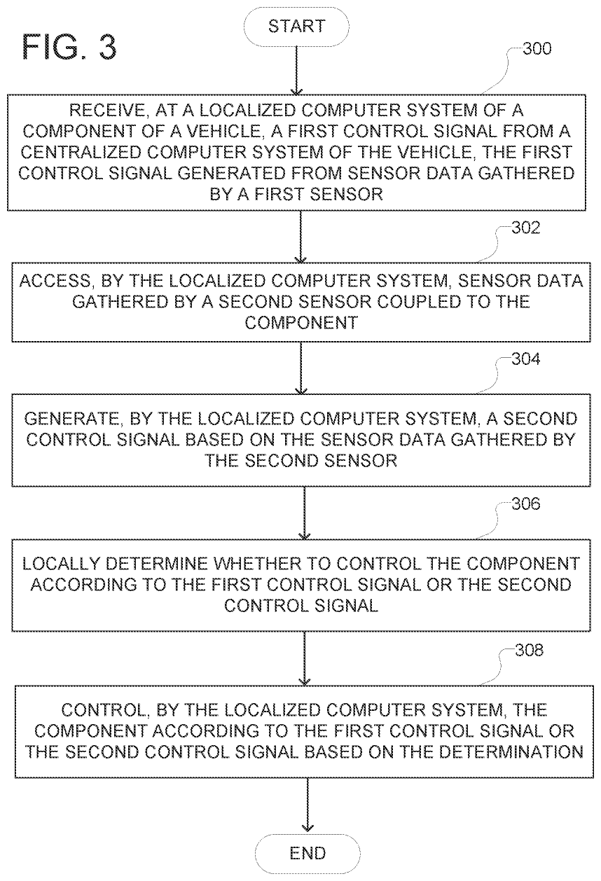

The disclosure now continues with a discussion of techniques for locally controlling a component as an intelligent component of a vehicle. Specifically, FIG. 3 illustrates a flowchart for an example method of locally controlling a component of a vehicle through a localized computer system. The method shown in FIG. 3 is provided by way of example, as there are a variety of ways to carry out the method. Additionally, while the example method is illustrated with a particular order of steps, those of ordinary skill in the art will appreciate that FIG. 3 and the modules shown therein can be executed in any order and can include fewer or more modules than illustrated. Each module shown in FIG. 3 represents one or more steps, processes, methods or routines in the method.

At step 300, a first control signal is received at a localized computer system of a component of a vehicle from a centralized computer system of the vehicle. The first control signal can be generated based on first sensor data gathered by a first sensor of the vehicle. Specifically, the first sensor can be coupled to the centralized computer system, and the centralized computer system can generate the first control signal based on sensor data generated by the first sensor. In turn, the centralized computer system can send the first control signal to the localized computer system.

The centralized computer system can generate the first control signal by running the sensor data gathered by the sensor through all or a portion of a software stack, such as the software stacks described herein. Specifically, the centralized computer system can run data through the perception stack, the prediction stack, the planning stack, and the controls stack to generate a first control signal from data gathered by the first sensor. Further, the centralized computer system can implement one or more applicable machine learning techniques in generating the control signal from data gathered by the first sensor. The first control signal may be a digital signal consisting of bits or an analog signal consisting of a electrical voltage or current. The first control signal may also be an acoustic signal consisting of pressure or acoustic pulses. The control signal may be encoded for compression or security.

At step 302, sensor data gathered by a second sensor coupled to the component is accessed by the localized computer system. Specifically, the localized computer system can access data gathered by a sensor that is localized with respect to the component. The second sensor can be directly coupled to the localized computer system. As follows, the second sensor can be coupled to the centralized computer system through the localized computer system. Further, the second sensor can be directly coupled to the centralized computer system.

At step 304, a second control signal is generated by the localized computer system based on the sensor data gathered by the second sensor. The localized computer system can implement one or more applicable software stacks for generating the second control signal from the sensor data gathered by the second sensor. For example, the localized computer system can implement a perception software stack and a controls software stack. In turn, the localized computer system can run the sensor data gathered by the second sensor through the perception software stack and the controls software stack to generate the second control signal. The localized computer system can implement one or more applicable machine learning techniques in generating the second control signal from data gathered by the second sensor.

The second control signal can cause the component to operate in a specific way as part of a total operation or move performed by the vehicle. Specifically, the second control signal can cause the component to operate as part of a fixed emergency move of the vehicle. For example, the second control signal can cause the tires of the vehicle to stop as part of an emergency braking move.

At step 306, it is locally determined whether to control the component according to the first control signal or the second control signal. Specifically, the localized computing system can determine whether to control the component according to the first control signal or the second control signal. More specifically, the localized computing system can determine whether to control the component according to the first control signal or the second control signal based on either or both the first control signal and the second control signals themselves. The localized computing system can locally determine whether to use the first or second control signal agnostic as to decision making input of the centralized computer system. For example, the localized computing system can locally determine whether to use the first or second control signals without any input from the centralized computer system, except for the first control signal itself which can be received from the centralized computer system.

In determining whether to use the first or second control signals based on the control signals themselves, the localized computing system can make the determination according to an override signal that is generated based on either or both the first control signal and the second control signal. Specifically, the localized computing system can default to using the first control signal received from the centralized computing system. As follows, the localized computing system can use the override signal to determine whether to override the first control signal and apply the second control signal that is generated by the localized computing system from the second sensor. In using the override signal to determine whether to override the first control signal, the localized computing system can compare the override signal to the first control signal itself in making the determination. Additionally, in using the override signal to determine whether to override the first control signal, the localized computing system can compare the override signal to a threshold value associated with the signal in making the determination. For example, if a magnitude of the first control signal is less than a magnitude of the override signal, then the localized computing system can determine to override the first control signal.

The localized computing system itself can generate the override signal, such that the override signal is indicative of a detected emergency situation associated with the vehicle. For example, an override signal generated in association with a suspension component can indicate that the vehicle is at risk of tipping over. The localized computing system can generate the override signal based on either or both the first control signal and the second control signal. Specifically, the localized computing system can generate the override signal as a function of a different between the first control signal and the second control signal.

At step 308, the component is controlled according to the first control signal or the second control signal based on the determination. More specifically, the localized computer system can control the component according to the first or second control signal based on the local determination of whether to control the component according to the first or second control signal.

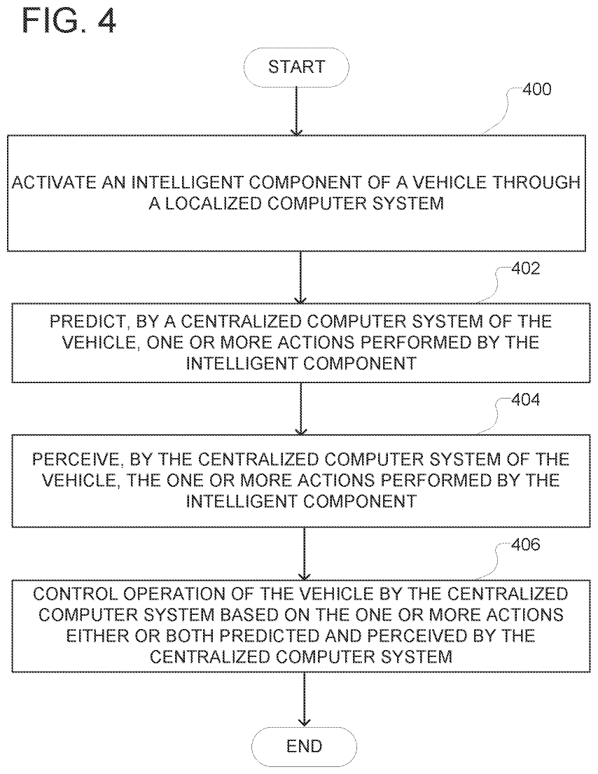

The disclosure now continues with a discussion of techniques for centrally managing the vehicle based on the operation of an intelligent component. Specifically, FIG. 4 illustrates a flowchart for an example method of centrally managing a vehicle based on either or both perceived and predicted operations of an intelligent component. The method shown in FIG. 4 is provided by way of example, as there are a variety of ways to carry out the method. Additionally, while the example method is illustrated with a particular order of steps, those of ordinary skill in the art will appreciate that FIG. 4 and the modules shown therein can be executed in any order and can include fewer or more modules than illustrated. Each module shown in FIG. 4 represents one or more steps, processes, methods or routines in the method.

At step 400, an intelligent component of a vehicle is activated through a localized computer system. Specifically, a component of a vehicle can be locally controlled through the localized computer system as part of activating the intelligent component. More specifically, the localized computer system can determine whether to control the component according to a control signal generated form a sensor associated with the component or through a control signal received from a centralized computer system of the vehicle.

At step 402, one or more actions that are performed by the intelligent component are predicted by the centralized computer system of the vehicle. The centralized computer system can use an applicable technique for predicting actions of a component of a vehicle to predict the actions of the intelligent component. For example, the centralized computer system can use a machine learning technique to predict that a tire has steered a specific direction.

At step 404, the one or more actions performed by the intelligent component are perceived by the centralized computer system of the vehicle. Perceived, as used herein with respect to intelligent component actions, includes identifying and interpreting the occurrence of the actions. In particular, perception can include identifying and interpreting the actions such that the vehicle can ultimately be controlled based on the actions. The centralized computer system of the vehicle can use an applicable technique for perceiving actions of a component of a vehicle to perceive the actions of the intelligent component. For example, the centralized computer system can use a machine learning technique to perceive that a windshield wiper has activated.

At step 406, operation of the vehicle is controlled by the centralized computer system based on the one or more actions of the component. Specifically, the centralized computer system can either perceive or predict the actions of the component and subsequently control operation of the vehicle based on either or both the perceived and predicted actions. In various instances the predicted and perceived actions of the intelligent component can be different leading to different ways in which the vehicle is ultimately controlled by the centralized computer system.

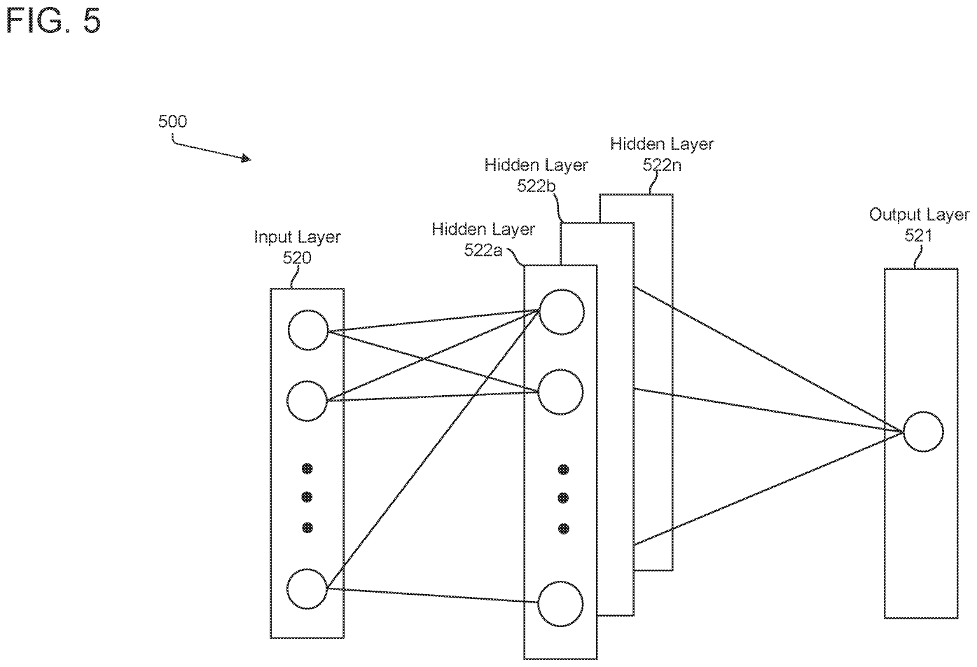

In FIG. 5, the disclosure now turns to a further discussion of models that can be used through the environments and techniques described herein. FIG. 5 is an example of a deep learning neural network 500 that can be used to implement all or a portion of the systems and techniques described herein. An input layer 520 can be configured to receive sensor data and/or data relating to an environment surrounding an AV. The neural network 500 includes multiple hidden layers 522a, 522b, through 522n. The hidden layers 522a, 522b, through 522n include “n” number of hidden layers, where “n” is an integer greater than or equal to one. The number of hidden layers can be made to include as many layers as needed for the given application. The neural network 500 further includes an output layer 521 that provides an output resulting from the processing performed by the hidden layers 522a, 522b, through 522n. In one illustrative example, the output layer 521 can provide estimated treatment parameters, that can be used/ingested by a differential simulator to estimate a patient treatment outcome.

The neural network 500 is a multi-layer neural network of interconnected nodes. Each node can represent a piece of information. Information associated with the nodes is shared among the different layers and each layer retains information as information is processed. In some cases, the neural network 500 can include a feed-forward network, in which case there are no feedback connections where outputs of the network are fed back into itself. In some cases, the neural network 500 can include a recurrent neural network, which can have loops that allow information to be carried across nodes while reading in input.

Information can be exchanged between nodes through node-to-node interconnections between the various layers. Nodes of the input layer 520 can activate a set of nodes in the first hidden layer 522a. For example, as shown, each of the input nodes of the input layer 520 is connected to each of the nodes of the first hidden layer 522a. The nodes of the first hidden layer 522a can transform the information of each input node by applying activation functions to the input node information. The information derived from the transformation can then be passed to and can activate the nodes of the next hidden layer 522b, which can perform their own designated functions. Example functions include convolutional, up-sampling, data transformation, and/or any other suitable functions. The output of the hidden layer 522b can then activate nodes of the next hidden layer, and so on. The output of the last hidden layer 522n can activate one or more nodes of the output layer 521, at which an output is provided. In some cases, while nodes in the neural network 500 are shown as having multiple output lines, a node can have a single output and all lines shown as being output from a node represent the same output value.

In some cases, each node or interconnection between nodes can have a weight that is a set of parameters derived from the training of the neural network 500. Once the neural network 500 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 500 to be adaptive to inputs and able to learn as more and more data is processed.

The neural network 500 is pre-trained to process the features from the data in the input layer 520 using the different hidden layers 522a, 522b, through 522n in order to provide the output through the output layer 521.

In some cases, the neural network 500 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 500 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ(1/2 (target-output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network 500 can perform a backward pass by determining which inputs (weights) most contributed to the loss of the network, and can adjust the weights so that the loss decreases and is eventually minimized.

The neural network 500 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 500 can include any other deep network other than a CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

FIG. 6 illustrates an example processor-based system with which some aspects of the subject technology can be implemented. For example, processor-based system 600 can be any computing device making up, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 600 includes at least one processing unit (Central Processing Unit (CPU) or processor) 610 and connection 605 that couples various system components including system memory 615, such as Read-Only Memory (ROM) 620 and Random-Access Memory (RAM) 625 to processor 610. Computing system 600 can include a cache of high-speed memory 612 connected directly with, in close proximity to, or integrated as part of processor 610.

Processor 610 can include any general-purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Static RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 630 can include software services, servers, services, etc., that when the code that defines such software is executed by the processor 610, it causes the system 600 to perform a function. In some embodiments, a hardware service that performs a particular function can include the software component stored in a computer-readable medium in connection with the necessary hardware components, such as processor 610, connection 605, output device 635, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A system comprising: a centralized computer system of a vehicle; a first sensor of the vehicle coupled to the centralized computer system; a second sensor of the vehicle; a component of the vehicle that is coupled to the centralized computer system and the second sensor, wherein the component comprises a localized computer system that is distinct from the centralized computer system and configured to: receive a first control signal from the centralized computer system, the first control signal generated by the centralized computer system based on first sensor data gathered by the first sensor; generate a second control signal based on second sensor data gathered by the second sensor; locally determine whether to control the component according to either the first control signal or the second control signal based on both the first control signal and the second control signal; and control the component according to either the first control signal or the second control signal based on a determination whether to control operation of the component according to either the first control signal or the second control signal.

Aspect 2. The system of Aspect 1, wherein the localized computer system is further configured to: generate an override signal based on the first control signal and the second control signal; and locally determine whether to override the first control signal and control the component according to the second control signal based on the override signal.

Aspect 3. The system of Aspects 1 and 2, wherein the localized computer system is further configured to locally determine whether to override the first control signal based on the override signal in comparison to a threshold.

Aspect 4. The system of Aspects 1 through 3, wherein the localized computer system is further configured to locally determine whether to override the first control signal based on the override signal in comparison to the first control signal.

Aspect 5. The system of Aspects 1 through 4, wherein the localized computer system is further configured to generate the override signal as a function of a difference between the first control signal and the second control signal.

Aspect 6. The system of Aspects 1 through 5, wherein the override signal is indicative of a detected emergency situation associated with the vehicle.

Aspect 7. The system of Aspects 1 through 6, wherein the second control signal causes the component to operate as part of a fixed emergency move of the vehicle.

Aspect 8. The system of Aspects 1 through 7, wherein the centralized computer system of the vehicle is further configured to perceive one or more actions performed by the component when the component is controlled according to the second control signal.

Aspect 9. The system of Aspects 1 through 8, wherein the centralized computer system of the vehicle is further configured to predict one or more actions performed by the component when the component is controlled according to the second control signal.

Aspect 10. The system of Aspects 1 through 9, wherein the centralized computer system of the vehicle is further configured to control operation of the vehicle based on one or more actions performed by the component when the component is controlled according to the second control signal.

Aspect 11. A method comprising: receiving, at a localized computer system of a component of a vehicle, a first control signal from a centralized computer system of the vehicle, wherein the first control signal is generated by the centralized computer system based on first sensor data gathered by a first sensor of the vehicle coupled to the centralized computer system; accessing, by the localized computer system, second sensor data gathered by a second sensor coupled to the component; generating, by the localized computer system, a second control signal based on the second sensor data; locally determining by the localized computer system whether to control the component according to either the first control signal or the second control signal based on both the first control signal and the second control signal; and controlling, by the localized computer system, the component according to either the first control signal or the second control signal based on a determination whether to control operation of the component according to either the first control signal or the second control signal.

Aspect 12. The method of Aspect 11, further comprising: generating, by the localized computer system, an override signal based on the first control signal and the second control signal; and locally determining by the localized computer system whether to override the first control signal and control the component according to the second control signal based on the override signal.

Aspect 13. The method of Aspects 11 and 12, further comprising locally determining by the localized computer system whether to override the first control signal based on the override signal in comparison to a threshold.

Aspect 14. The method of Aspects 11 through 13, further comprising locally determining by the localized computer system whether to override the first control signal based on the override signal in comparison to the first control signal.

Aspect 15. The method of Aspects 11 through 14, further comprising generating the override signal as a function of a difference between the first control signal and the second control signal.

Aspect 16. The method of Aspects 11 through 15, wherein the override signal is indicative of a detected emergency situation associated with the vehicle.

Aspect 17. The method of Aspects 11 through 16, wherein the second control signal causes the component to operate as part of a fixed emergency move of the vehicle.

Aspect 18. The method of Aspects 11 through 17, wherein the centralized computer system of the vehicle is further configured to either or both perceive and predict one or more actions performed by the component when the component is controlled according to the second control signal.

Aspect 19. The method of Aspects 11 through 18, wherein the centralized computer system of the vehicle is further configured to control operation of the vehicle based on one or more actions performed by the component when the component is controlled according to the second control signal.

Aspect 20. A non-transitory computer-readable storage medium having stored therein instructions which, when executed by one or more processors, cause the one or more processors to: receive, at a localized computer system of a component of a vehicle, a first control signal from a centralized computer system of the vehicle, wherein the first control signal is generated by the centralized computer system based on first sensor data gathered by a first sensor of the vehicle coupled to the centralized computer system; access, by the localized computer system, second sensor data gathered by a second sensor coupled to the component; generate, by the localized computer system, a second control signal based on the second sensor data; locally determine by the localized computer system whether to control the component according to either the first control signal or the second control signal based on both the first control signal and the second control signal; and control, by the localized computer system, the component according to either the first control signal or the second control signal based on a determination whether to control operation of the component according to either the first control signal or the second control signal.

Aspect 21. A system comprising means for performing a method according to any of Aspects 11 through 19.

What is claimed is:

1. A system comprising:
a centralized computer system of a vehicle;
a first sensor of the vehicle coupled to the centralized computer system;
a second sensor of the vehicle; and
a component of the vehicle that is coupled to the centralized computer system and the second sensor, wherein the component comprises a localized computer system that is distinct from the centralized computer system and configured to:
receive a first control signal from the centralized computer system, the first control signal generated by the centralized computer system based on first sensor data gathered by the first sensor;
generate a second control signal based on second sensor data gathered by the second sensor;
locally determine whether to control the component according to either the first control signal or the second control signal based on both the first control signal and the second control signal; and
control the component according to either the first control signal or the second control signal based on a determination whether to control the component according to either the first control signal or the second control signal.

2. The system of claim 1, wherein the localized computer system is further configured to:
generate an override signal based on the first control signal and the second control signal; and
locally determine whether to override the first control signal and control the component according to the second control signal based on the override signal.

3. The system of claim 2, wherein the localized computer system is further configured to locally determine whether to override the first control signal based on the override signal in comparison to a threshold.

4. The system of claim 2, wherein the localized computer system is further configured to locally determine whether to override the first control signal based on the override signal in comparison to the first control signal.

5. The system of claim 2, wherein the localized computer system is further configured to generate the override signal as a function of a difference between the first control signal and the second control signal.

6. The system of claim 2, wherein the override signal is indicative of a detected emergency situation associated with the vehicle.

7. The system of claim 1, wherein the second control signal causes the component to operate as part of a fixed emergency move of the vehicle.

8. The system of claim 1, wherein the centralized computer system of the vehicle is further configured to perceive one or more actions performed by the component when the component is controlled according to the second control signal.

9. The system of claim 1, wherein the centralized computer system of the vehicle is further configured to predict one or more actions performed by the component when the component is controlled according to the second control signal.

10. The system of claim 1, wherein the centralized computer system of the vehicle is further configured to control operation of the vehicle based on one or more actions performed by the component when the component is controlled according to the second control signal.

11. A method comprising:
receiving, at a localized computer system of a component of a vehicle, a first control signal from a centralized computer system of the vehicle, wherein the first control signal is generated by the centralized computer system based on first sensor data gathered by a first sensor of the vehicle coupled to the centralized computer system;
accessing, by the localized computer system, second sensor data gathered by a second sensor coupled to the component;
generating, by the localized computer system, a second control signal based on the second sensor data;
locally determining by the localized computer system whether to control the component according to either the first control signal or the second control signal based on both the first control signal and the second control signal; and
controlling, by the localized computer system, the component according to either the first control signal or the second control signal based on a determination whether to control the component according to either the first control signal or the second control signal.

12. The method of claim 11, further comprising:
generating, by the localized computer system, an override signal based on the first control signal and the second control signal; and
locally determining by the localized computer system whether to override the first control signal and control the component according to the second control signal based on the override signal.

13. The method of claim 12, further comprising locally determining by the localized computer system whether to override the first control signal based on the override signal in comparison to a threshold.

14. The method of claim 12, further comprising locally determining by the localized computer system whether to override the first control signal based on the override signal in comparison to the first control signal.

15. The method of claim 12, further comprising generating the override signal as a function of a difference between the first control signal and the second control signal.

16. The method of claim 12, wherein the override signal is indicative of a detected emergency situation associated with the vehicle.

17. The method of claim 12, wherein the second control signal causes the component to operate as part of a fixed emergency move of the vehicle.

18. The method of claim 11, wherein the centralized computer system of the vehicle is further configured to either or both perceive and predict one or more actions performed by the component when the component is controlled according to the second control signal.

19. The method of claim 11, wherein the centralized computer system of the vehicle is further configured to control operation of the vehicle based on one or more actions performed by the component when the component is controlled according to the second control signal.

20. A non-transitory computer-readable storage medium having stored therein instructions which, when executed by one or more processors, cause the one or more processors to:
receive, at a localized computer system of a component of a vehicle, a first control signal from a centralized computer system of the vehicle, wherein the first control signal is generated by the centralized computer system based on first sensor data gathered by a first sensor of the vehicle coupled to the centralized computer system;
access, by the localized computer system, second sensor data gathered by a second sensor coupled to the component;
generate, by the localized computer system, a second control signal based on the second sensor data;
locally determine by the localized computer system whether to control the component according to either the first control signal or the second control signal based on both the first control signal and the second control signal; and
control, by the localized computer system, the component according to either the first control signal or the second control signal based on a determination whether to control the component according to either the first control signal or the second control signal.
